(19) United States
(12) Patent Application Publication
(10) Pub. No.: US 2024/0193143 A1
(43) Pub. Date: Jun. 13, 2024

(54) OPTIMIZED SEARCHING BASED ON SELF-BALANCED INDEX STORING AT SEARCHERS IN A DISTRIBUTED ENVIRONMENT

(71) Applicant: VMware, Inc., Palo Alto, CA (US)

(72) Inventors: Ivan Dimitrov Duhov, Sofia (BG); Ivo Georgiev Gaydajiev, Sofia (BG); Dimitar Veskov Petkov, Sofia (BG); Ivelin Bozhidarov Pavlov, Ruse (BG); Antonio Kristiyanov Filipov, Sofia (BG)

(21) Appl. No.: 18/078,054

(22) Filed: Dec. 8, 2022

(51) Int. Cl. G06F 16/22; G06F 16/23; G06F 16/27

(52) U.S. Cl. CPC G06F 16/2228; G06F 16/2379; G06F 16/27

(57) ABSTRACT

Hosting indices of different customers on searchers provided by one or more distributed storage systems can be implemented as computer-readable methods, media and systems. Statistical data for a set of indices is obtained, where each index is to be hosted on a searcher of a plurality of searchers. Scores for each index are calculated for a first searcher, where each index is associated with a respective customer of a set of customers, and the calculating is based on evaluating data for targeted average distributions of indices of each customer at the first searcher. A subset of indices are identified to be hosted at the first searcher based on evaluating the calculated scores. A request to secure an index from the identified subset of indices for hosting the index on the first searcher is initiated, and the index is hosted on the first searcher.

### BACKGROUND

This specification relates to data storage and data processing.

Software applications or services can provide services and access to resources on a network. In some cases, data is stored for events executed by different customers and maintained at a common data storage. Data storages support data organization and search executions.

### SUMMARY

This specification describes technologies related to execution of searches over a dynamic distributed database system including searchers storing indices of data of different customers.

In some implementations, a searcher of a distributed database system obtains data for a set of indices, where each index is to be hosted at either that searcher or at another searcher from a plurality of searchers provided at the distributed database system. The searchers of the distributed database system provide data persistency and compete to store indices for the customers with other searchers. When an index is stored at a searcher, the data in the index becomes searchable.

In particular, this specification describes a method including: obtaining data for a set of indices, each index to be hosted on a searcher of a plurality of searchers; calculating, for a first searcher, scores for each index from the set of indices, wherein each index of the set of indices is associated with a respective customer of a set of customers, wherein the calculating is based on evaluating data for targeted average distributions of indices of each customer at the first searcher; identifying a subset of indices to be hosted at the first searcher based on evaluating the calculated scores; and initiating to secure an index from the identified subset of indices for hosting the index on the first searcher.

Particular embodiments of the subject matter described in this specification can be implemented so as to realize one or more of the following advantages.

When indices of a particular customer are distributed evenly between one or more searchers of a distributed database system, the distributed database system is more efficient to process search requests for that customer. The searchers at the distributed database system store indices for various customers. Even or balanced distribution of the amount of indices of a customer (or each of the customers) over the searchers can also improve the general search performance of the database system. Since a searcher may not be overloaded with indices of one customer but rather shares the load of storing indices for that customer with other searchers in an even manner, the searcher may be less likely to experience processing overload that could prevent the searcher from providing search services for other customers and/or searches. If the searchers have random number of searchers hosted, then the load on the system can be unevenly distributed between the searchers so that the searcher that has the most indices would have the highest load. Such a searcher load can result in a delay of the search execution time if it is overloaded with search tasks, or can be a bottleneck for executing other searches for indices of other customer on that same searcher.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram illustrating an example computing environment for storing of indices at a plurality of searchers in a distributed environment.

FIG. 2 is a schematic diagram illustrating an example distributed database environment including a searcher that self-balances its load for storing indices associated with different customers.

FIG. 3 is a flowchart of an example process for distributing indices of corresponding customers at a respective searcher from searchers maintained at a distributed database system to balance the load when executing searching for each of the customers.

Like reference numbers and designations in the various drawings indicate like elements.

### DETAILED DESCRIPTION

This specification describes techniques for hosting indices of different customers on searchers provided by one or more distributed storage systems. The indices can store respective collections of customer data that is to be persisted on the distributed database. The searchers can be computing environment instances for hosting one or more indices and their corresponding collections of customer data to be persisted. Generally, in a data-driven world, there is a huge amount of data generated by customers from different types of software applications (services) and/or systems. The data generation can be associated with different use case scenarios. For example, the data can be related to events executed in a particular computing environment(s). Such data needs to be stored and in some instances be further analyzed, for example, to be used for subsequent actions or executions.

In some implementations, distributed storage system(s) such as database systems can store data for multiple customers, where the data for each customer is hosted on multiple searchers. In some implementations, data is grouped in batches, for example, of a particular size, and these batches will be referred to in this specification as indices. In some implementations, each index can be a batch of data of a particular customer and thus can only include data for that single customer. Additionally, a customer may be associated with multiple indices depending on the amount of data for the customer being persisted.

In some implementations, indices, either related to a single customer or correspondingly related to different customers, are generated based on raw input data from customers. Searchers at the distributed database environment can host indices for various customers up to the storage capacity of the searcher. A searcher can store indices and delete indices, based on requests and/or data retention policies.

In some implementations, once indices with the data of the customers are stored at a distributed storage system, the indices become searchable to support execution of different searches in relation to portions or all of the data related to one or more corresponding customers. Based on identifying a customer related to a received search request, one or more searchers that store indices of that customer may be searched by customer users to provide a search result, e.g., by returning data related to or responsive to the search.

In accordance with at least some of the implementations of the present specification, the indices are distributed over the searchers based on a statistical self-balancing technique where each searcher can determine whether to host or not host an index (or indices) that needs to be hosted on the distributed storage system(s).

Searching indices of a customer stored at searchers can be a resource-intensive operation since searches run over those of the searchers that host indices for the particular customer. If a search is received for a customer whose indices are distributed unevenly, for example only at a portion of all the searchers, then more searchers would be used for executing the search and/or more searchers would be occupied with executing the search, for example, for longer period of time or occupying more of the processing computing power, and such execution may not be optimal. Thus, in accordance with the implementations of the present disclosure, a targeted average distribution of indices of each customer over each of the plurality of searchers provided by the storage environment can be used in the process of hosting indices. Such a distribution, as described in detail below, can balance the spread of indices over the searcher to improve timeliness and efficiency of searching.

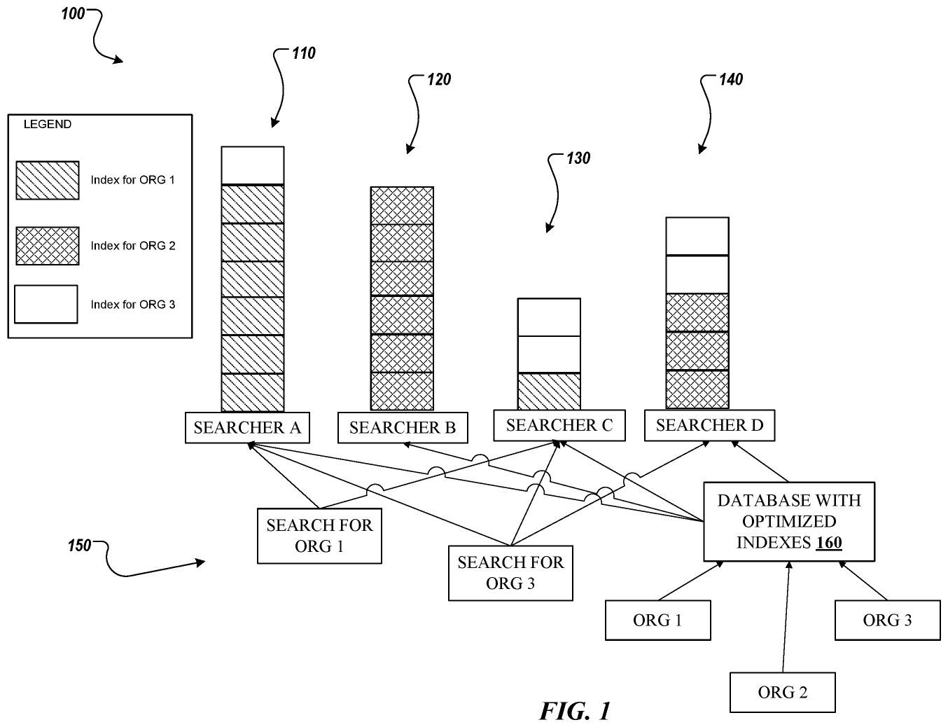

FIG. 1 is a schematic diagram illustrating an example computing environment 100 that supports storing of indices at a plurality of searchers in a distributed environment.

When a customer generates data, that data can be used to create an one or more indices, where the one or more indices can be stored in a distributed storage system, and in this particular example, at a database 160. The database 160 can be, for example, a NoSQL database. The indices stored at the database can be associated with a customer. A customer can be an organization an account, or else. In some implementations, an index is generated based on one or multiple streams of raw data. In some implementations, indices go through different lifecycle stages until they reach an index state that is included in the database 160. For example, raw index data can be created in one or multiple streams at a customer application and/or system and that raw index data can be merged to optimize the data. Generated raw index data can be maintained at one or more storage spaces and can be merged at a separate storage space, for example, based on merging rules. For example, the optimization of the merged raw index data can include one or more of filtering of redundant data, removing replications, or deletion of empty records, among other examples. Generated merged raw index data can be provided for hosting at the database 160.

In some implementation, the database 160 includes a pool of indices that is dynamically updated with new indices based on data provided from one or more customers. In some implementations, the database 160 includes optimized indices that are generated based on merging and filtering raw index data from a respective organization.

Multiple searchers 110, 120, 130, and 140 can separately evaluate whether or not to host an index or more from the indices at the database 160. The evaluation can be done contemporaneously by each of the searcher or sequentially, or in a substantially parallel manner. The evaluation of the indices at the database 160 is performed periodically by each or some of the searchers, for example, at a predefined time period. When an index is stored at a searcher, the index becomes searchable. For example, a searcher determines whether to host an index based on a random selection and current capacity state. Thus, the indices are stored at the distributed database environment and the distribution of indices of different customers can be a random distribution throughout the whole set of searchers. Once an index is stored at a single searcher, it becomes searchable in response to queries submitted to the database 160.

In some implementations, the distribution of the indices from the database 160 to each of the searchers 110, 120, 130, and 140 can be done on a random basis and/or according to a consecutive order of requests from the searchers to host one or more of the indices. For example, all searchers may have the same number of indices per customer. In another example, few searchers, such as two or three searchers, can host a large number of indices for a single customer. In a particular example, 16 indices of one customer can be distributed equally between two searchers, where there are 10 searchers in total and each searcher is capable of storing eight indices of substantially similar size. In some examples, not all searchers host indices up to their storage capacity. For example, one searcher may store one index, while another searcher can store eight indices, even if both searchers have the same storage capacity.

If a search for a customer is received in the context of the example of distributing sixteen indices of that customer between two searchers out of ten searchers, the searching load would be concentrated on those two searchers and the execution of these searcher would depend on the processing capacity of each single searcher. For example, if the searcher has four processing capacity units, then for a single time unit, four searches can be executed over four indices, and then eight indices can be searched in two time units. In some implementations, in cases where one searcher cannot process a search on eight indices simultaneously, the execution of the search would be delayed when compared to executing a search of eight (8) indices distributed at two searchers evenly, where each searcher has four (4) processing capacity units.

In accordance with the implementations of the present disclosure, when the indices are distributed evenly between searchers in view of the total amount of searchers, their respective storage capacity, their processing capacity, and the total amount of indices per customer, the searching operation can be executed with improved processing efficiency and faster.

In some implementations, when the database 160 receives new indices, those indices can be distributed between the four searchers in an attempt to improve the status of each searcher for the number of indices per each customer. In some implementations, each searcher can determine whether adding a new index of a particular customer would bring the number of indices on that searcher closer to a targeted average number of indices of that customer on the searcher. Similarly, a searcher can determine that the additional hosting of an new index for the particular customer would not bring the search closer to the targeted average number of indices of that customer, and as a result, determine not to host the new index. A searcher can have a target average number of indices per customer that are defined based on statistical information for the amount of data stored at the distributed environment for each customer. For example, based on the statistical data that at the distributed environment there are 20 indices of customer A and there are five searchers, each searcher can target to store four indices of customer A. Thus, a searcher can determine to host an index of customer A, when the searcher stores indices that are below that average number of four. In such manner, the addition of one more index of that customer would improve the number of the stored indices of that customer to have a smaller difference with the targeted average number compared to the differences with the targeted average number without hosting such index.

For example, the distribution of the indices over the searchers as presented on FIG. 1 does not optimize the search process execution. Indeed, as shown, searcher 110 would be overloaded when executing a search for organization 1 and this may lead to downtime for executions of searches for organization 3. Therefore, in accordance with the implementations of the present disclosure, the four searchers can be configured to implement logic to evaluate whether or not to host an index in an attempt to balance the distribution of indices per customer over each of the searchers, and indirectly to affect the distribution for the whole distributed database setup. Such distribution can support efficient search execution.

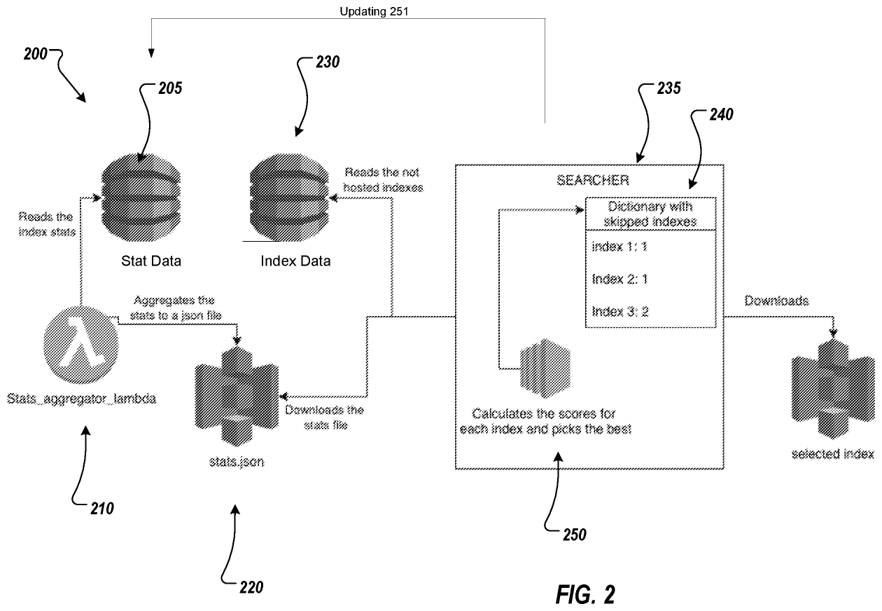

FIG. 2 is a schematic diagram illustrating an example distributed database environment 200 including a searcher 235 that self-balances its load for storing indices associated with different customers.

The distributed database environment 200 can include multiple searchers including the searcher 235. The searcher 235 can be substantially similar to any one of the searchers 110, 120, 130, and 140 of FIG. 1. The searchers obtain statistical data 205 for indices that are hosted on searchers of the distributed database environment 200.

A statistic aggregator 210 reads the statistical data 205 that includes information for indices generated for different customer that are already hosted on the plurality of searchers of the distributed database system. The statistical data 205 for the indices can include information such as a customer name, a customer identifier (ID), or some other configured security code. The statistical data 205 is updated when new indices are hosted on one or more of the searchers that host indices. The statistics aggregator 210 aggregates the statistical data 205 to determine targeted average distributions of indices of each customer for the searcher 235 (and some or all of the other searchers not shown).

In some implementations, the statistical data 205 stores data related to hosted indices at the plurality of searches and their respective customer. The statistics aggregator 210 obtains the statistical data 205 and determine a targeted average distribution of indices, defined per customer, over a set of searchers from the multiple searcher. A statistics file 220 can be generated based on executing the aggregation logic over the statistical data 205 for already hosted indices.

For example, a determined number of indices divided by the number of searchers can be considered as a targeted average distribution of indices of a customer at each of the searchers. For example, if a set of three searchers store four indices of a particular customer, than each searcher should have a targeted distribution for that customer equal to 1.3 indices.

In some implementations, a set of indices are evaluated by the searcher 235 to determine which ones of those indices to host. In some implementations, the searcher can obtain data about these indices that are available for hosting from index data 230.

The index data 230 can include information about indices that are yet to be hosted and include information such as:
size of the index,
the type of data in the index,
the customer related to the index, and/or
a number of times that index has been evaluated prior this evaluation of the data 205.

In some implementations, the searcher 235 can determine which of the indices as identified in the index data 230 would be initiated to be secured and later hosted by the searcher 235 based on balancing logic implemented at the searcher 235. The balancing logic can be based on considerations to distribute equal number of indices per searcher for each of the customers.

In some implementations, the searcher 235 determined which of the indices as identified in the index data 230 based on i) the statistical file 220 that defines a targeted average distribution for each customer at the searcher 235 and ii) index data 230 for indices that are expected to be hosted.

In some implementations, when a searcher obtains an index of that customer to determine whether to host the index, if the searcher has zero (0) indices of that customer, than it can be determined to request to host this index to improve the distribution state of the searcher (that is equal to 0 since no indices of that customer were stored).

In some implementations, index data 230 can be data for indices that are to be hosted on the searcher 235 of a plurality of searchers. The index data 230 is used to determine information for each of the indices that are available for hosting. Based on the data about each index obtained from 230, and data about targeted average distributions of indices for different customers at the searcher 235, the searcher 235 can determine whether to host each one of the indices defined in the index data 230.

In some implementations, the statistics file 220 includes information about the current number of searchers that are online and available to host indices and statistics for each customer regarding each number of indices stored at each searcher. In some implementations, the statistical aggregator updates the statistics file 220 on regular basis or dynamically upon receiving of updated information at the statistical data 205. For example, the statistical data 205 is a database that is updated any time there is an operation executed in relation to an index at the plurality of searcher. For example, the executed operation can be an addition of a searcher, a modification of an added searcher, a deletion of a searcher, other.

In some implementations, the searcher 235 processes data for each of the indices identified in the index data 230. A calculator 250 can determine a score for each of these indices based on the statistical file 220 that defined a target average distribution for each customer. In some implementations, the searcher 235 uses a formula to determine relatively how much of the quota (number of indices) defined by the target average distribution of indices of a particular customer is filled in with indices of that customer that are already stored. For example, the formula to determine score for each index that is not yet hosted, can be based on the index data 230 and statistical file 220 and can be as follows:

score:=((target average number of indices of Customer×1−current number of indices of Customer×1)/target average number of indices of Customer×1)*100. (1)

The target average distribution number can be interpreted as a number of indices that are expected to be hosted on the searcher 235, and the current number of indices is the number of indices already hosted by the searcher 235.

In some implementations, by defining the score for each index that is evaluated by the searcher 235, the searcher 235 can determine which index from the not yet hosted indices would affect the balance of the searcher 235 and therefore improve searching performance and the searcher 235 can determine which index would not improve the searching performance. The score takes values between [-inf; 100], where 100 can be interpreted as that there no indices for that customer on searcher 235. Scores that are below zero (0) are scores related to indices that if added would negatively impact the balance of the searcher 235, and thus indirectly affect the searching performance of the whole distributed database.

In some implementations, the searcher 235 determines to initiate a request to secure to host those of the indices that have the highest score values. For example, the highest score values can be determined as indices associated with scores that are above a threshold value, or that are the highest ranked indices of a threshold number, such as five highest ranked indices. Even if the searcher 235 initiates to host a set of indices, another searcher may have requested to host one or more of the indices in that set. One or more processes can be carried out by the system to determine which searcher of one or more submitting requests, will actually host each index. Thus, when multiple searchers are scoring a given index the searcher 235 might not be able to host the index despite a determination to initiate the request based on the score evaluation.

For each index that has a negative score, an identifier for the index is saved in a dictionary 240, for example as a key-value pair with the index identifier as the key and the number of times the index was skipped as the value. The number of times an index is skipped can track the number of times that the searcher evaluated an index and determined that the score is below a threshold value for hosting (e.g., zero) and did not initiate to secure the index. For example, if no searcher has a score greater than zero another round of scoring is performed by each searcher including the searcher 235. Each time an index is scored with a negative score, the searcher 235 can check the dictionary 240 to determine whether the number of times the index has been skipped exceeds a threshold value and, in response to the threshold value being exceeded the search can decide to host the index or not.

When the searcher 235 evaluates indices and the calculator 250 computes the scores for each index, indices with negative scores are tracked in the dictionary 240 and the number of times that the index is evaluated and not hosted (or skipped) is incrementally increased and maintained at the dictionary 240. The number of times of an index being skipped is compared with a threshold number of times for evaluation of the index. In some implementations, if the number of times is reached and/or exceeded, the searcher 235 determines to host the index even if the index is with a negative score. In some implementations, the dictionary 240 is maintained up-to-date based on evaluations performed by searcher 235 for incoming indices, and the data 230 and 220. In some implementations, the dictionary 235 is maintained at the searcher 235 or at an external connected storage.

For example, when the searcher 240 determine not to host one index, there may be another searcher at the distributed database environment that does determine to host that index. However, if there is no searcher that hosts that index, then indices are evaluated based on data in dictionaries to determine when to host an index even if it is with a negative score. Once the value stored in the dictionary and defining the number of times that an index has been evaluated to be with a negative score (and thus not hosted) reaches a particular threshold, the searcher 235 can determine to secure and host the index. In some implementations, the reaching of a particular threshold can be interpreted as an acknowledgment that the index (e.g., to a threshold degree of certainty) has not been hosted on any other searcher and to avoid downtime of hosting services for that index, the index is hosted at the searcher 235.

In some implementations, different searchers can be configured with the same threshold values to evaluate the number of time that an index has been evaluated. In those cases, the searcher 240 can determine to host an index, where another searcher may also determine to host that same index. Thus, two indices may initiate to secure the same index. The distributed database system can include distribution logic to determine which one of the searchers would obtain the index and would host it. In some implementations, different searchers can be configured with different threshold values, for example, different threshold values for some or all customers, or based on storage amount considerations, among other examples criteria for determining whether to host indices. For example, the searcher 240 can be a first searcher to determine to host an index that is evaluated with a negative score for a number of time that exceed a respective threshold value for the customer associated with that index.

Once an index is hosted, than the dictionary 240 can be updated and information for that index can be erased from the dictionary as no longer relevant for that index. In some implementations, the dictionary 240 is maintained up-to-date based on evaluations performed by searcher 235 for incoming indices and the data 230 and 220.

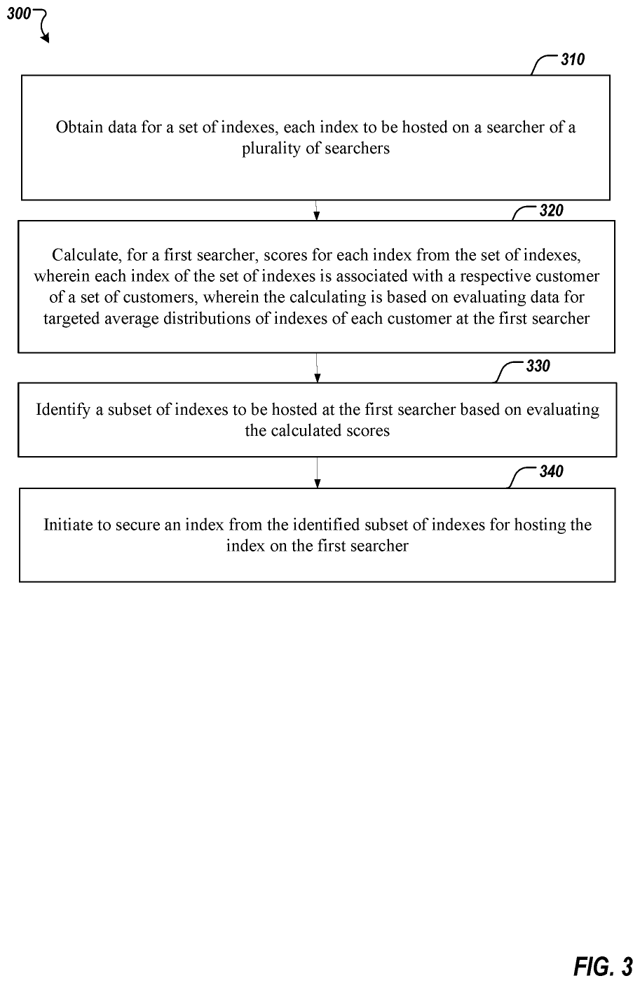

FIG. 3 is a flowchart of an example process 300 for distributing indices of corresponding customers at a respective searcher from searchers maintained at a distributed database system to balance the load when executing searching for each of the customers. The example process 300 can be executed at a computing environment substantially similar to the environment 100 of FIG. 1 and 200 of FIG. 2. The method 300 can be executed in relation to a searcher 235 of FIG. 2 that can determine whether or not to request and subsequently host an index.

At 310, a searcher or a data evaluator communicatively coupled to the searcher obtains data for one or more indices, each of the one or more indices to be hosted on a searcher of a plurality of searchers.

At 310, a first searcher calculates scores for each index from the one or more indices, wherein each index of the set of indices is associated with a respective customer of a set of customers. The calculation is based on evaluating data for targeted average distributions of indices of each customer at the first searcher.

At 320, the searcher identifies a subset of indices to be hosted at the first searcher based on evaluating the calculated scores.

In some implementations, once the calculator 250 calculates the scores for each of the indices identified in the index data 230, the scores can be ordered in a descending order, and a very first set of indices from the ordered sequence can be used to initiate the request to be secured by the searcher 235. The very first indices can be determined as a subset of indices of a given threshold number, as a number of indices that can match a current available capacity for hosting indices at the searcher 235, and/or as a subset of indices that meet a particular inclusion criteria for hosting indices on the searcher 235.

At 330, the searcher initiates to secure an index from the identified subset of indices for hosting the index on the searcher.

In some implementations, after the first searcher hosts a subset of indices from the indices for which data is obtained, the first searcher obtains a subsequent set of indices for hosting. In some implementations, the first searcher obtains new set of data for a subsequent set of indices and evaluates such data according to a predefined time schedule for pulling such data. In some instances, the first searcher can have a time schedule that is defined with regular time intervals, for example, every five minutes, once a day, or other time period. In some instances, the first searcher can be configured to obtain data about indices that are available for hosting based on a configured pulling regime at the first searcher or based on a configured push regime at the database storing the indices before they are hosted, or combination of those regimes.

In some implementations, the time gap between subsequent evaluations of indices by one searcher, such as the first searcher, may allow for other searchers of the distributed database environment to have also obtained data for indices that are available for hosting. The other searchers can also calculate scores and identified indices for hosting, substantially similar to the operations 310, 320, and 330 performed by the first searcher. Further, a subsequent set of data for a subsequent set of indices available for hosting can be evaluated in a substantially similar manner as discussed above in relation to the initial set of indices and FIG. 2. By providing time between evaluations performed by one searcher, the other searchers of the distributed database system can be provided with the option to also evaluate data for indices and initiate corresponding requests to secure indices that can overlap with indices evaluated by the first searcher. In that manner, the distributed database system supports balanced distribution of indices per customer on the searchers themselves and for the whole system.

In some implementations, the first searcher evaluates the subsequent set by calculating scores (as discussed above) for each index from the subsequent set of indices. The calculation is based on evaluating new data defining updated target average distributions of indices based at least on the at least one index hosted on the first searcher of the plurality of searchers. In some implementations, the searcher 235 can update (at 251) the statistical data 205 after the searcher 235 has hosted one or more new indices. Once the searcher 235 hosts an index, the statistical data 205 can be updated as well as the index data 230 defining the indices that are yet to be hosted.

In some implementations, the distributed storage includes multiple searchers in additions to searcher 235 that are each configured to score new indices to determine whether to initiate a request to host. The plurality of searchers have a substantially similar storage capacity to host indices and a substantially similar processing capacity to execute parallel searches over hosted indices. For a given group of one or more new indices, one or more searchers can contemporaneously score each index and independently determine whether to initiate a request to host the index. If more than one initiates a request to host the index, the distributed storage may be configured to apply distribution logic to determine which one of the searchers will be assigned to host the index. For example, the determination may be based on defined rules for different customers mapped to different searchers, storage capacity considerations, storage amount per customer at each searcher, or else. If none of the searchers initiates a request to host the index based on the respective scores, each searcher can maintain information for scored indices at a dictionary that can be locally or externally hosted. If a searcher does not initiate a request to host an index and none of the other searchers requested to host that index and actually hosted it, then the searcher can obtain data for that index again and perform evaluation by calculating a score and determining whether to initiate a request to host the index or to add data for the index at the dictionary. For example, if the searcher does not initiate to host the index after performing a second or subsequent evaluation of data for indices, the searcher can incrementally increase a value for that index that indicates the number of times the index has been evaluated and was determined to be with a negative score.

Embodiments of the subject matter described in this specification include computer systems, apparatus, and computer programs recorded on one or more computer storage devices, each configured to perform the actions of the described methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communications network. Examples of communications networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Example 1 is a computer-implemented method comprising:
obtaining statistical data for a set of indices, each index to be hosted on a searcher of a plurality of searchers;
calculating, for a first searcher, scores for each index from the set of indices, wherein each index of the set of indices is associated with a respective customer of a set of customers, wherein the calculating is based on evaluating data for targeted average distributions of indices of each customer at the first searcher;
identifying a subset of indices to be hosted at the first searcher based on evaluating the calculated scores; and
initiating a request to secure an index from the identified subset of indices for hosting the index on the first searcher; and
hosting the index on the first searcher.

Example 2. The method of Example 1, comprising:
hosting at least one of the subset of indices on the first searcher;
obtaining a subsequent set of indices to be hosted on the first searcher; and
calculating scores for each index from the subsequent set of indices, wherein the calculating is based on evaluating new data defining updated target average distributions of indices based at least on the at least one index hosted on the first searcher of the plurality of searchers.

Example 3. The method of any one of the previous Examples, wherein each index includes only a set of data records of a respective customer of the set of customers, and wherein each searcher of the plurality of searchers is a computing environment instances that hosts indices of one or more of the set of customers.

Example 4. The method of any one of the previous Examples, wherein the plurality of searchers have a substantially similar storage capacity to host indices, and wherein the plurality of searchers have a substantially similar processing capacity to execute parallel searches over hosted indices.

Example 5. The method of any one of the previous Examples, comprising:
maintaining searcher statistical data for storages of indices at the plurality of searchers, the searcher statistical data including data for each searcher, wherein each searcher hosts indices of one or more customers of the set of customers; and
determining a targeted average number of indices of each customer of the set of customers at the first searcher based on evaluating the searcher statistical data.

Example 6. The method of Example 5, wherein the calculation of the scores for each index for the first searcher is based on comparing a difference between the targeted average number of indices of the first customer at the first searcher as determined based on the maintained searcher statistical data and a currently hosted number of indices of the first customer at the first searcher.

Example 7. The method of any one of the previous Examples, wherein
calculating the scores for each index from the set of indices comprises:
   ordering the scores for each index in a descending order;
identifying the subset of indices comprises:
   identifying a very first set of indices from the descending order, wherein the very first set of indices match with a current available capacity for hosting indices on the first searcher, and wherein each index from the very first set of indices has a score that meets inclusion criteria for hosting indices on the first searcher.

Example 8. The method of any one of the previous Examples, wherein identifying the subset of indices to be hosted comprises:
evaluating the calculated scores for each index to exclude an index associated with a score that is below a threshold value for inclusion in the subset of indices.

Example 9. The method of Example 8, comprising:
storing data in a dictionary, maintained at the first searcher, storing data identifying numbers of occurrences of indices during iterations of obtaining sets of indices at the first searcher, wherein two subsequent iteratively obtained sets of indices include at least one identical indices obtained for hosting,
in response to determining that i) an identified number of occurrence of the index obtained with the set of indices is above a threshold value for inclusion into the subset of indices and ii) a calculated score for the index is below the threshold value for inclusion in the subset of indices,
   determining to host the index on the first searcher.

Example 10. The method of any one of the previous Examples, wherein the plurality of searchers are identifying simultaneously indices from the obtained set of indices for hosting, wherein obtained set of indices is provided from a pool of indices that is dynamically updated with indices based on data provided from one or more of the set of customers.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination or in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous.

What is claimed is:

1. A computer-implemented method comprising:
obtaining statistical data for a set of indices, each index to be hosted on a searcher of a plurality of searchers;
calculating, for a first searcher, scores for each index from the set of indices, wherein each index of the set of indices is associated with a respective customer of a set of customers, wherein the calculating is based on evaluating data for targeted average distributions of indices of each customer at the first searcher;
identifying a subset of indices to be hosted at the first searcher based on evaluating the calculated scores; and
initiating a request to secure an index from the identified subset of indices for hosting the index on the first searcher; and
hosting the index on the first searcher.

2. The method of claim 1, comprising:
hosting at least one of the subset of indices on the first searcher;
obtaining a subsequent set of indices to be hosted on the first searcher; and
calculating scores for each index from the subsequent set of indices, wherein the calculating is based on evaluating new data defining updated target average distributions of indices based at least on the at least one index hosted on the first searcher of the plurality of searchers.

3. The method of claim 1, wherein each index includes only a set of data records of a respective customer of the set of customers, and wherein each searcher of the plurality of searchers is a computing environment instances that hosts indices of one or more of the set of customers.

4. The method of claim 1, wherein the plurality of searchers have a substantially similar storage capacity to host indices, and wherein the plurality of searchers have a substantially similar processing capacity to execute parallel searches over hosted indices.

5. The method of claim 1, comprising:
maintaining searcher statistical data for storages of indices at the plurality of searchers, the searcher statistical data including data for each searcher, wherein each searcher hosts indices of one or more customers of the set of customers; and
determining a targeted average number of indices of each customer of the set of customers at the first searcher based on evaluating the searcher statistical data.

6. The method of claim 5, wherein the calculation of the scores for each index for the first searcher is based on comparing a difference between the targeted average number of indices of the first customer at the first searcher as determined based on the maintained searcher statistical data and a currently hosted number of indices of the first customer at the first searcher.

7. The method of claim 1, wherein
calculating the scores for each index from the set of indices comprises:
ordering the scores for each index in a descending order;
identifying the subset of indices comprises:
identifying a very first set of indices from the descending order, wherein the very first set of indices match with a current available capacity for hosting indices on the first searcher, and wherein each index from the very first set of indices has a score that meets inclusion criteria for hosting indices on the first searcher.

8. The method of claim 1, wherein identifying the subset of indices to be hosted comprises:
evaluating the calculated scores for each index to exclude an index associated with a score that is below a threshold value for inclusion in the subset of indices.

9. The method of claim 8, comprising:
storing data in a dictionary, maintained at the first searcher, storing data identifying numbers of occurrences of indices during iterations of obtaining sets of indices at the first searcher, wherein two subsequent iteratively obtained sets of indices include at least one identical indices obtained for hosting,
in response to determining that i) an identified number of occurrence of the index obtained with the set of indices is above a threshold value for inclusion into the subset of indices and ii) a calculated score for the index is below the threshold value for inclusion in the subset of indices,
determining to host the index on the first searcher.

10. The method of claim 1, wherein the plurality of searchers are identifying simultaneously indices from the obtained set of indices for hosting, wherein obtained set of indices is provided from a pool of indices that is dynamically updated with indices based on data provided from one or more of the set of customers.

11. A non-transitory, computer-readable medium coupled to one or more processors and having instructions stored thereon which, when executed by the one or more processors, cause the one or more processors to perform operations, the operations comprising:
obtaining statistical data for a set of indices, each index to be hosted on a searcher of a plurality of searchers;
calculating, for a first searcher, scores for each index from the set of indices, wherein each index of the set of indices is associated with a respective customer of a set of customers, wherein the calculating is based on evaluating data for targeted average distributions of indices of each customer at the first searcher;
identifying a subset of indices to be hosted at the first searcher based on evaluating the calculated scores; and
initiating a request to secure an index from the identified subset of indices for hosting the index on the first searcher; and
hosting the index on the first searcher.

12. The computer-readable medium of claim 11, comprising instructions stored thereon, which, when executed by the one or more processors, cause the one or more processors to perform operations, the operations comprising:
hosting at least one of the subset of indices on the first searcher;
obtaining a subsequent set of indices to be hosted on the first searcher; and
calculating scores for each index from the subsequent set of indices, wherein the calculating is based on evaluating new data defining updated target average distributions of indices based at least on the at least one index hosted on the first searcher of the plurality of searchers.

13. The computer-readable medium of claim 11, wherein each index includes only a set of data records of a respective customer of the set of customers, and wherein each searcher of the plurality of searchers is a computing environment instances that hosts indices of one or more of the set of customers.

14. The computer-readable medium of claim 11, wherein the plurality of searchers have a substantially similar storage capacity to host indices, and wherein the plurality of searchers have a substantially similar processing capacity to execute parallel searches over hosted indices.

15. The computer-readable medium of claim 11, comprising instructions stored thereon, which, when executed by the one or more processors, cause the one or more processors to perform operations, the operations comprising:
maintaining searcher statistical data for storages of indices at the plurality of searchers, the searcher statistical data including data for each searcher, wherein each searcher hosts indices of one or more customers of the set of customers; and
determining a targeted average number of indices of each customer of the set of customers at the first searcher based on evaluating the searcher statistical data.

16. The computer-readable medium of claim 15, wherein the calculation of the scores for each index for the first searcher is based on comparing a difference between the targeted average number of indices of the first customer at the first searcher as determined based on the maintained searcher statistical data and a currently hosted number of indices of the first customer at the first searcher.

17. A system comprising
a computing device; and
a computer-readable storage device coupled to the computing device and having instructions stored thereon which, when executed by the computing device, cause the computing device to perform operations, the operations comprising:
obtaining statistical data for a set of indices, each index to be hosted on a searcher of a plurality of searchers;
calculating, for a first searcher, scores for each index from the set of indices, wherein each index of the set of indices is associated with a respective customer of a set of customers, wherein the calculating is based on evaluating data for targeted average distributions of indices of each customer at the first searcher;
identifying a subset of indices to be hosted at the first searcher based on evaluating the calculated scores; and
initiating a request to secure an index from the identified subset of indices for hosting the index on the first searcher; and
hosting the index on the first searcher.

18. The system of claim 17, wherein the computer-readable storage device comprises instructions stored thereon, which, when executed by the computing device, cause the computing device to perform operations, the operations comprising:
hosting at least one of the subset of indices on the first searcher;
obtaining a subsequent set of indices to be hosted on the first searcher; and
calculating scores for each index from the subsequent set of indices, wherein the calculating is based on evaluating new data defining updated target average distributions of indices based at least on the at least one index hosted on the first searcher of the plurality of searchers.

19. The system of claim 17, wherein each index includes only a set of data records of a respective customer of the set of customers, and wherein each searcher of the plurality of searchers is a computing environment instances that hosts indices of one or more of the set of customers.

20. The system of claim 19, wherein the plurality of searchers have a substantially similar storage capacity to host indices, and wherein the plurality of searchers have a substantially similar processing capacity to execute parallel searches over hosted indices.
